(19) United States
(12) Patent Application Publication
(10) Pub. No.: US 2009/0184183 A1
(43) Pub. Date: Jul. 23, 2009

(54) FUEL INJECTION DEVICE FOR AN INTERNAL COMBUSTION ENGINE

(76) Inventors: Falko Bredow, Remseck (DE); Martin Katz, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/303,164

(22) PCT Filed: Apr. 25, 2007
(86) PCT No.: PCT/EP07/54063

§ 371 Date: Dec. 2, 2008

(30) Foreign Application Priority Data
Jun. 9, 2006 (DE) 10 2006 026 877.6

(51) Int. Cl. B05B 1/30; F02M 61/20

(52) U.S. Cl. 239/584; 239/533.9

(57) ABSTRACT

A fuel injection device for an internal combustion engine includes a housing and a valve element arranged within the housing. The valve element interacts with a valve seat lying in the region of a fuel outlet opening. It is proposed that at least one control piston and a nozzle needle of the valve element be coupled to one another via a hydraulic coupler. The hydraulic coupler has a coupling space and a non-return valve connected to the coupling space and which opens away therefrom.

### PRIOR ART

The invention relates to a fuel injection device for an internal combustion engine as generically defined by the preamble to claim 1.

A fuel injection device is known on the market with which the fuel can be injected directly into a combustion chamber, associated with it, of an internal combustion engine. To that end, a valve element is disposed in a housing and has a pressure face that is operative overall in the opening direction of the valve element, in the region of a fuel outlet opening. On the opposite end of the valve element there is a control face, which acts in the closing direction and defines a control chamber. The control face acting in the closing direction is larger overall than the pressure face that is operative in the opening direction when the valve element is open.

When the fuel injection device is closed, a high fuel pressure, of the kind furnished by a common fuel line (rail) is present in a region of the pressure face that acts in the opening direction and of the control face that acts in the closing direction. For opening the valve element the pressure applied to the control face is lowered, until the resultant hydraulic force at the pressure face and acting in the opening direction exceeds the force acting in the closing direction. As a result, opening of the valve element is brought about.

### DISCLOSURE OF THE INVENTION

Technical Object

The object of the present invention is to refine the fuel injection device of the type defined at the outset in such a way that it is as simple and inexpensive as possible in construction and functions as reliably as possible.

Technical Solution

This object is attained by a fuel injection device having the characteristics of claim 1. Advantageous refinements of the invention are recited in dependent claims. Important characteristics of the invention can also be learned from the ensuing description and from the drawings. It should be noted at this point that the characteristics may also be essential to the invention in quite various combinations without these being explicitly referred to.

Advantageous Effects

In the fuel injection device of the invention, as a result of the hydraulic coupling of the control rod and the nozzle needle, the freedom in designing the fuel injection device is increased considerably, since the various parts of the valve element can each be adapted optimally to the site inside the fuel injection device. For instance, the elastic properties of the valve element can be optimally adapted to the intended area of use by means of a suitable choice of the material used and the dimensions. Moreover, the production of the valve element is facilitated substantially overall, since even parts with a constant diameter can be used. This allows a construction of the fuel injection device with simple parts, which on the one hand facilitates manufacture and on the other makes a small construction possible. To realize the present invention, numerous components of previous devices can moreover continue to be used.

A further advantage of the hydraulic coupler is that tolerances are compensated for, which makes production and assembly simpler. Coupling the control rod and the nozzle needle of the valve element by means of a hydraulic coupler furthermore allows a certain motion damping to be attained.

By means of the check valve provided according to the invention, the coupling chamber can be relieved after a closing event of the valve element. This is based on the following thought: With the valve element open and the attendant pressure reduction in the coupling chamber, an inflow of hydraulic fluid into the coupling chamber occurs because of unavoidable leakage. This means that upon closure of the valve element, there is more fluid in the coupling chamber than before the valve element was opened. The check valve provided according to the invention now prevents the control piston, whenever the nozzle needle comes into contact with the valve seat, from being seated on a “fluid cushion” that was not yet present before the valve element was opened. In the least favorable case, this fluid cushion would increase in size every time the valve element opens and closes, until opening the valve element would no longer be possible at all. Thus by means of the check valve, the reliability in operation of the fuel injection device of the invention, and above all the replicability of the initial and final states, are markedly improved.

In a first advantageous refinement, it is proposed that a valve element of the check valve is urged into its closing position by a spring. On the one hand, by means of such a spring the valve element is securely held even in the pressureless state of repose of the fuel injection device. On the other, such a spring makes it possible to set a certain opening pressure difference, thus assuring secure closure of the nozzle needle.

The refinement of the fuel injection device of the invention, in which the check valve opens toward a high-pressure region, points in the same direction. Moreover, such a fuel injection device is simple to manufacture, since such a high-pressure region is typically present immediately adjacent the hydraulic coupler.

It is especially advantageous if a valve element of the check valve has a maximum stroke such that a predetermined time interval can be maintained between a closure and an ensuing opening of the valve element of the fuel injection device. Above all for multiple injections within one work cycle, very short time intervals between a closure and an opening of the valve element are necessary. By limiting the maximum stroke of the check valve element, it is assured that the check valve can close quickly when the pressure in the hydraulic coupling chamber begins to drop at the onset of an opening event.

A gap between the control piston and a housing section that demarcates the coupling chamber from a high-pressure chamber can be designed such that an opening of the nozzle needle occurs in delayed fashion. As a result, the least-quantity capability of the fuel injection device of the invention is improved: In an opening motion of the control piston, fluid in fact passes through the gap reach the coupling chamber, which leads to a delayed reaction of the nozzle needle. This differs from the closing situation, in which, no later than when the control piston comes into contact with the nozzle needle, the nozzle needle is forced to close immediately.

The precision in the fuel injection device and its replicability are improved still further if the fuel injection device includes a connecting conduit, which leads from a high-pressure chamber to the valve seat located in the region of the fuel outlet opening, and if an orifice region of the connecting conduit toward the high-pressure chamber is embodied in such a way that pressure waves are reduced. As a result, the fact is suitably taken into account that pressure waves in the high-pressure chamber, because of its comparatively large volume, play a lesser role there, but this is not true for the connecting conduit that has a comparatively small volume and for the pressure chamber immediately upstream of the valve seat. By a suitable design of the orifice, the pressure waves that occur in the high-pressure chamber can be reduced or damped, at least in the direction of the connecting conduit. One simple possibility for doing so is to embody the orifice in funnel-like form. As a result, pressure waves that arrive at the orifice “peter out”.

### BRIEF DESCRIPTION OF THE DRAWINGS

An especially preferred exemplary embodiment of the present invention will be described in further detail below in conjunction with the accompanying drawings In the drawings:

FIG. 1 is a schematic illustration of an internal combustion engine with a fuel injection device;

FIG. 2 is a schematic illustration, partly in section, of the fuel injection device of FIG. 1; and

FIG. 3 is a more-detailed illustration of one region of the fuel injection device of FIG. 1.

### EMBODIMENTS OF THE INVENTION

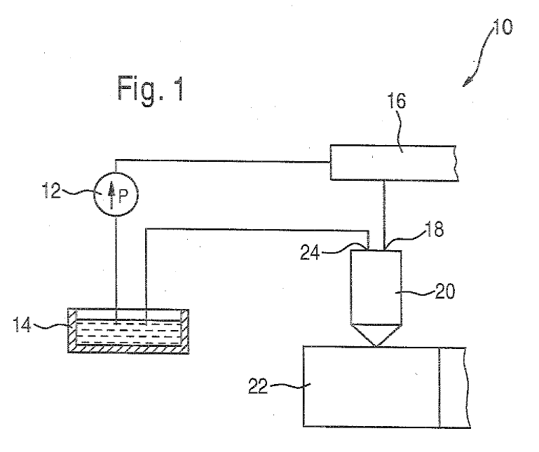

In FIG. 1, an internal combustion engine is identified in general by reference numeral 10. It serves in this example to drive a motor vehicle, not shown. A high-pressure pumping device 12 pumps fuel from a fuel tank 14 into a fuel pressure reservoir 16 (“rail”). In it, fuel, such as diesel or gasoline, is stored at very high pressure. By means of a high-pressure connection 18, a plurality of fuel injection devices 20 are connected to the rail 16; they inject the fuel directly into combustion chambers 22 associated with them. The fuel injection devices 20 each have a low-pressure connection 24 as well, by way of which they are in communication with a low-pressure region, in this example with the fuel tank 14.

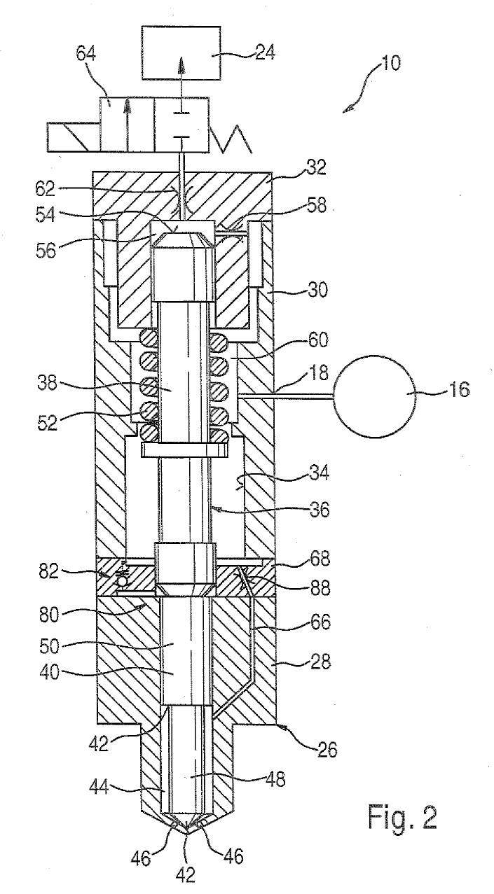

As can be seen from FIG. 2, the fuel injection device 20 includes a housing 26 with a nozzle body 18, a main body 30, and a terminal body 32. In the housing, there is a stepped recess 34 in the longitudinal direction of the housing, and a needle-like valve element 36 is received in this recess. The valve element is in two parts: It comprises a control piston 38 and a nozzle needle 40.

The nozzle needle 40 has pressure faces 42, which define a pressure chamber 44 and whose resultant hydraulic force resultant points in the opening direction of the nozzle needle 40. On its lower end in terms of FIG. 2, the nozzle needle 40 cooperates, in a manner not shown in further detail in FIG. 2, with a valve seat (not identified by reference numeral) toward the housing. In this way, fuel outlet openings 46 can be disconnected from the pressure chamber 44 or made to communicate with it. The nozzle needle 40 has one portion 48 of smaller diameter and one portion 50 of larger diameter. With the portion 50, the nozzle needle 40 is longitudinally displaceably guided in the nozzle body 28.

The control piston 38 is received in the main body 30. An upper terminal region, in terms of FIG. 2, of the control piston 38 is embodied as a guide, which is received and guided in the terminal body 32. A spring 52 is braced on a shoulder. formed by an annular collar (not identified by reference numeral), on the control piston 38 and urges the control piston in the closing direction. The upper axial end face, in FIG. 2, of the control piston 38 forms a hydraulic control face 34 acting in the closing direction of the valve element 36. The control face, together with the terminal body 32. defines a hydraulic control chamber 56.

The control chamber 56 communicates via an inlet throttle restriction 58 in the terminal body 32 with a high-pressure chamber 60, which because of its large volume can also be called a reservoir and which communicates with the high-pressure connection 18. The control chamber 56 is furthermore connected, via an outlet throttle restriction 62 that is machined into the terminal body 32, to an electromagnetically actuated 2/2-way switching valve 64. Depending on the switching position, this valve either connects the outlet throttle restriction 62 with the low-pressure connection 24 or blocks it. The high-pressure chamber 60, in a manner to be described hereinafter, also communicates with the pressure chamber 44 via a connecting conduit 66.

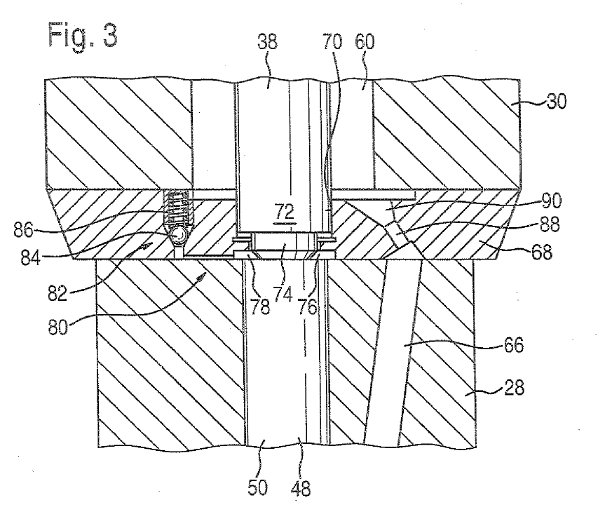

A disklike guide element 68 is clamped between the nozzle body 28 and the main body 30. The detailed construction of this guide element is shown in FIG. 3: The guide element 68 includes a graduated through bore (not identified by reference numeral), whose upper region, in terms of FIG. 3, forms a housing section 70. In it, a lower terminal region 72, in terms of FIGS. 2 and 3, of the control piston 38 is guided with a sliding fit. The diameter of the terminal region 72 is somewhat greater than the diameter of the portion 50 of the nozzle needle 40, but less than the diameter of the control piston 38 in the region that is guided in the terminal body 32. These diameter ratios are important for the function of the fuel injection device 10. It can be seen from FIG. 3 that the control piston 38, below the terminal region 72, also has a terminal peg 74, whose diameter is less than that of the terminal region 72 and even less than the region, adjacent to the control piston 38, of the nozzle needle 40. Approximately at the axial level of this terminal peg 74, an encompassing annular collar 76, which forms a stop for the nozzle needle 40 since its inside diameter is less than the outside diameter of the terminal region adjacent to it of the nozzle needle 40, extends radially inward from the through bore in the guide element 68. The stop 76 is not absolutely necessary, however.

The annular chamber formed between the terminal peg 74, the terminal region 72, the nozzle needle 40, and the guide element 68, is called the coupling chamber 78. As will be described in further detail hereinafter, it is part of a hydraulic coupler 80, by means of which the motions of the control piston 38 and of the nozzle needle 40 are coupled to one another. The hydraulic coupler 80 also includes a check valve 82, with a valve element 84 embodied as a ball that is urged by a valve spring 86 into a closing position. In the open state, the check valve 82 causes the hydraulic coupling chamber 78 to communicate with the high-pressure chamber 60. The check valve 82 is arranged such that it opens away from the coupling chamber 78 toward the high-pressure chamber 60.

A portion of the connecting conduit 66 located in the guide element 68 includes a flow throttle restriction 88. an orifice region 90 of the connecting conduit 66 toward the high-pressure chamber 60 is embodied in funnel-like form. The fuel injection device 20 functions as follows: In the outset state, with the switching valve 64 currentless, the hydraulic control chamber 56 is disconnected from the low-pressure connection 24 and communicates via the inlet throttle restriction 58 with the high-pressure connection 18 and thus with the rail 16. Thus the same pressure prevails in the hydraulic control chamber 56 as in the high-pressure chamber 60. In the stationary outset state, this pressure also prevails in the pressure chamber 44 via the connecting conduit 66. Because of a certain leakage between the housing section 70 of the guide element 68 and the terminal region 72 of the control piston 38 as well as leakage between the nozzle needle 40 and the nozzle body 28 in the portion 50, this pressure also prevails in the coupling chamber 78. In this configuration, overall, a force acting in the closing direction of the valve element 36 is operative and presses the valve element against the valve seat in the region of the fuel outlet openings 46.

If current is then supplied to the switching valve, the outlet throttle restriction 62 communicates with the low-pressure connection 24. As a result, the pressure in the hydraulic control chamber 56 drops. In the coupling chamber 78, conversely, the high outset pressure initially still prevails. Therefore all in all, a force results that acts in the opening direction on the control piston 38. The control piston thus begins to move upward, counter to the force of the spring 52, in terms of FIGS. 2 and 3. Hence as a result of the increase in volume, the pressure in the coupling chamber 78 drops while in the pressure chamber 44, the high outset pressure still prevails. Overall, a force acting in the opening direction therefore acts on the nozzle needle 40 as well now, because of which the nozzle needle 40 begins to move upward in terms of FIGS. 2 and 3; that is, it lifts from its valve seat in the region of the fuel outlet openings 46. Thus fuel can be injected from the rail 16 into the combustion chamber 22, via the high-pressure connection 18, the high-pressure chamber 60, the connecting conduit 66, the pressure chamber 44, and the fuel outlet openings 46. Because of the flow throttle restriction 88 in the connecting conduit 76, a lesser pressure results in the pressure chamber 44 than in the high-pressure chamber 60.

Since in the coupling chamber 78 as well, a lesser pressure prevails at least intermittently than in the high-pressure chamber 60, a certain fuel quantity passes from the pressure chamber 44 into the coupling chamber 78, through the guide gap between the housing section 70 and the terminal region 72 of the high-pressure chamber 60 and between the nozzle needle 40 and the nozzle body 28 in the portion 50. By purposefully dimensioning the aforementioned guide gap, the fuel quantity that spills over from the high-pressure chamber 60 into the coupling chamber 78 can be adjusted, which in turn enables targeted setting of the opening behavior of the valve element 36. The larger the guide gap, the more “damped” the drop in pressure in the coupling chamber 78, and the delayed the reaction of the nozzle needle 40. This is helpful above all whenever the fuel injection device 20 needs to be able to inject even extremely small quantities.

For terminating an injection, the switching valve 64 is returned to its closed position, in which the communication of the hydraulic control chamber 56 with the low-pressure connection 24 is blocked. Via the inlet throttle restriction 58, the pressure in the hydraulic control chamber 56 rises. As a result, the control piston 38 is moved back in the closing direction, since the pressure in the coupling chamber 78 is initially still less than in the hydraulic control chamber 56. As a consequence, the pressure in the coupling chamber 78 rises again, because of the reduction in volume, and this in the final analysis leads to an overall force acting on the nozzle needle 40 in the closing direction of the nozzle needle. The motion of the nozzle needle 40 is at an end when it again rests with its lower end, in terms of FIG. 2, on the valve seat toward the housing, and hence fuel can no longer emerge through the fuel outlet openings 46. Since as has already been mentioned above, fuel has in the meantime flowed from the high-pressure chamber 60 and the pressure chamber 44 to reach the coupling chamber 78, the control piston 38 at the end of its closing motion strikes a “fuel cushion”, which leads to a dynamic pressure increase in the coupling chamber 78, to a pressure that is higher than the pressure in the high-pressure chamber 60. As a consequence, the check valve 82 opens, so that the fuel that has been forced into the coupling chamber 78 can escape into the high-pressure chamber 60. The control piston 38, at the end of its closing motion, therefore comes into contact with the nozzle needle 40 again.

If the fuel injection device 20 is intended to inject fuel by means of a plurality of injections in rapid succession, then the valve element 36 must be capable of opening again immediately after reaching its closing position. This is on the condition that, once “excess” fuel present in the coupling chamber 78 has been carried away via the check valve 82 into the high-pressure chamber 60, the coupling chamber 78 becomes a self-contained volume again as fast as possible, which couples the nozzle needle 40 with the opening motion of the control piston 38. This is attained by limiting the stroke of the valve element 84 of the check valve 82 to a very slight maximum stroke. Thus if the pressure in the coupling chamber 78 drops again because of an opening motion of the control piston 38, then the valve element 84 needs to execute only a slight stroke until it is again in its closed position, and the coupling chamber 78 can thus form a self-contained volume.

The design of the orifice region 90 of the connecting conduit 66 in the form of a funnel that becomes wider toward the high-pressure chamber 60 has the following effect: The opening and closure of the valve element 36 cause pressure fluctuations in the high-pressure chamber 60, but because of the size of the high-pressure chamber 60, they are hardly perceptible. The connecting conduit 66 and the pressure chamber 44, however, have a markedly lesser volume than the high-pressure chamber 60, so that pressure fluctuations have a more pronounced effect there and would reduce the precision of the injection. This is where the funnel-shaped orifice region 90 comes into play: By means of it, pressure waves striking the orifice region 90 are “scattered” or reduced, so that only diminished pressure fluctuations reach the connecting conduit 66. The fuel can therefore be metered with especially high precision using the fuel injection device 20 presented here.

1-7. (canceled)

8. A fuel injection device for an internal combustion engine, comprising:
a housing;
a valve element disposed in the housing, the valve element having at least one control piston and one nozzle needle;
a valve seat disposed in the housing in the region of at least one fuel outlet opening, the valve element cooperating with the valve seat; and
a hydraulic coupler coupling the at least one control piston and one nozzle needle of the valve element, the hydraulic coupler including a coupling chamber and a check valve which communicates with the coupling chamber and opens away from the coupling chamber.

9. The fuel injection device according to claim 8, wherein a valve element of the check valve is urged into its closing position by a spring.

10. The fuel injection device according to claim 8, wherein the check valve opens toward a high-pressure chamber.

11. The fuel injection device according to claim 9, wherein the check valve opens toward a high-pressure chamber.

12. The fuel injection device according to claim 8, wherein a valve element of the check valve has a maximum stroke such that a predetermined time interval can be maintained between a closure and an ensuing opening of the valve element of the fuel injection device.

13. The fuel injection device according to claim 9, wherein a valve element of the check valve has a maximum stroke such that a predetermined time interval can be maintained between a closure and an ensuing opening of the valve element of the fuel injection device.

14. The fuel injection device according to claim 11, wherein a valve element of the check valve has a maximum stroke such that a predetermined time interval can be maintained between a closure and an ensuing opening of the valve element of the fuel injection device.

15. The fuel injection device according to claim 8, wherein a gap between the control piston and a housing section that demarcates the coupling chamber from a high-pressure chamber is designed such that an opening of the nozzle needle occurs in delayed fashion.

16. The fuel injection device according to claim 9, wherein a gap between the control piston and a housing section that demarcates the coupling chamber from a high-pressure chamber is designed such that an opening of the nozzle needle occurs in delayed fashion.

17. The fuel injection device according to claim 10, wherein a gap between the control piston and a housing section that demarcates the coupling chamber from the high-pressure chamber is designed such that an opening of the nozzle needle occurs in delayed fashion.

18. The fuel injection device according to claim 12, wherein a gap between the control piston and a housing section that demarcates the coupling chamber from a high-pressure chamber is designed such that an opening of the nozzle needle occurs in delayed fashion.

19. The fuel injection device according to claim 14, wherein a gap between the control piston and a housing section that demarcates the coupling chamber from the high-pressure chamber is designed such that an opening of the nozzle needle occurs in delayed fashion.

20. The fuel injection device according to claim 8, further comprising a connecting conduit, which leads from a high-pressure chamber to the valve seat located in the region of the fuel outlet opening; and that an orifice region of the connecting conduit toward the high-pressure chamber is embodied in such a way that pressure waves are reduced.

21. The fuel injection device according to claim 9, further comprising a connecting conduit, which leads from a high-pressure chamber to the valve seat located in the region of the fuel outlet opening; and that an orifice region of the connecting conduit toward the high-pressure chamber is embodied in such a way that pressure waves are reduced.

22. The fuel injection device according to claim 10, further comprising a connecting conduit, which leads from the high-pressure chamber to the valve seat located in the region of the fuel outlet opening; and that an orifice region of the connecting conduit toward the high-pressure chamber is embodied in such a way that pressure waves are reduced.

23. The fuel injection device according to claim 12, further comprising a connecting conduit, which leads from a high-pressure chamber to the valve seat located in the region of the fuel outlet opening; and that an orifice region of the connecting conduit toward the high-pressure chamber is embodied in such a way that pressure waves are reduced.

24. The fuel injection device according to claim 19, further comprising a connecting conduit, which leads from the high-pressure chamber to the valve seat located in the region of the fuel outlet opening; and that an orifice region of the connecting conduit toward the high-pressure chamber is embodied in such a way that pressure waves are reduced,

25. The fuel injection device as defined by claim 20, wherein the orifice region is funnel-shaped.

26. The fuel injection device as defined by claim 21, wherein the orifice region is funnel-shaped.

27. The fuel injection device as defined by claim 24, wherein the orifice region is funnel-shaped.
